(19) United States
(12) Patent Application Publication
(10) Pub. No.: US 2026/0096586 A1
(43) Pub. Date: Apr. 9, 2026

(54) COMPOSITIONS AND METHODS FOR ACTIVATING GLP-1 SECRETION

(71) Applicant: LifeVantage Corporation, Lehi, UT (US)

(72) Inventors: Elisa Diane BARNES, Draper, UT (US); Christina Beer, Salt Lake City, UT (US); Clinton T. Horton, Salt Lake City, UT (US); Robert A. Carr, American Fork, UT (US)

(21) Appl. No.: 18/910,816

(22) Filed: Oct. 9, 2024

(51) Int. Cl. A23L 33/105; A23L 33/125; A23L 33/135; A23L 33/16

(52) U.S. Cl. CPC A23L 33/105; A23L 33/125; A23L 33/135; A23L 33/16

(57) ABSTRACT

Nutritional supplements and compositions for activating the GLP-1 peptide and/or other hormones in a subject in order to regulate blood sugar, weight, and hunger of the subject are described in this application. The compositions include a first nutritional supplement containing specific amounts of hydrolyzed Acacia gum, lemon bioflavonoids, chromium, Berberis aristate, and hesperidin. The compositions also include a second nutritional supplement containing specific amounts of flax seed oil, resistant potato starch, resistant tapioca fiber, kombucha, Bacillus coagulans, Bacillus clausii, and allulose. A third composition includes the first and second nutritional supplements containing these ingredients in sufficient amounts to regulate the GLP-1 peptide and/or other hormones. These compositions are able to increase the GLP-1 concentration in the blood by up to about 140% without binding directly to any GLP-1 receptors. Other embodiments are also described.

### BACKGROUND

This application relates to compositions for activating the GLP-1 hormone in a subject. Specifically, this application describes nutritional supplements and compositions for activating the GLP-1 and other hormones in a subject in order to regulate blood sugar, weight, and hunger of the subject.

### SUMMARY

This application relates generally to nutritional supplements and compositions for activating the GLP-1 hormone and/or other hormones in a subject in order to regulate blood sugar, weight, and hunger of the subject. The compositions include a first nutritional supplement containing specific amounts of hydrolyzed acacia gum, lemon bioflavonoids, chromium, berberis aristate, and hesperidin. The compositions also include a second nutritional supplement containing specific amounts of flax seed oil, resistant potato starch, resistant tapioca fiber, kombucha, Bacillus coagulans, Bacillus clausii, and allulose. A third composition includes the first and second nutritional supplements containing these ingredients in sufficient amounts to regulate the GLP-1 hormone and/or other hormones. These compositions are able to increase the GLP-1 concentration in the blood by up to about 140% without binding directly to any GLP-1 receptors.

### BRIEF DESCRIPTION OF DRAWINGS

The following description can be better understood in light of the Figures that show various embodiments and configurations of the imaging systems and methods. Together with the following description, the Figures demonstrate and explain the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices and methods.

FIG. 1 illustrates the mechanism for creation of the GLP-1 hormone in the body from proglucagon.

FIG. 2 shows the activity of dipeptidyl peptidase-4 enzyme on GLP-1 to break down GLP-1 to an inactive form.

FIG. 3 shows the activity of the PPY and PYY peptides.

FIG. 4 shows an image of the GLP-1 hormone secreted in control cells not treated with any of the compositions described herein.

FIG. 5 shows an image of the GLP-1 hormone secreted in cells treated with the MB Core™ compositions described herein.

FIG. 6 shows an image of the GLP-1 hormone secreted in cells treated with the MindBody GLP-1 System™ compositions as described herein.

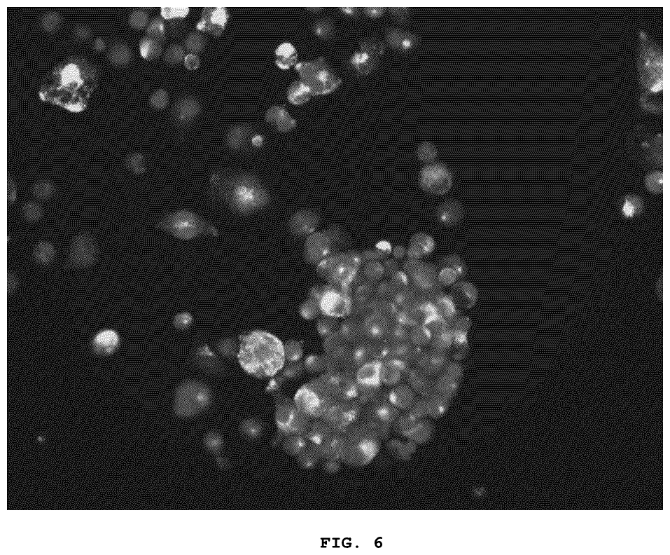

FIG. 7 depicts the in-vitro % change in mRNA GCG Gene Expression using the compositions described herein.

FIG. 8 shows the in-vitro % change in mRNA PCSK1 Gene Expression using the compositions described herein.

FIG. 9 depicts the in-vitro % change in mRNA DPP4 Gene Expression using the compositions described herein.

FIG. 10 shows the in-vitro % change in mRNA GLP1R Gene Expression using the compositions described herein.

FIG. 11 depicts the in-vitro % change in mRNA PPY Gene Expression using the compositions described herein.

FIG. 12 depicts the in-vitro % change in mRNA PYY Gene Expression using the compositions described herein.

FIG. 13 shows the in-vitro % change in the GLP-1 production using the compositions described herein.

FIG. 14 shows the average % change in blood GLP-1 concentration for a group of subjects that consumed the compositions described herein.

### DETAILED DESCRIPTION

The following description supplies specific details in order to provide a thorough understanding. Nevertheless, the skilled artisan will understand that the described methods and systems can be implemented and used without employing these specific details. Indeed, the described systems and methods can be placed into practice by modifying the described systems and methods and can be used in conjunction with any other apparatus and/or techniques conventionally used in the industry. For example, while the description below focuses on compositions and nutritional supplements and cosmetics for humans, it could be adapted and modified for other industries, such as animals or other uses such as being part of a functional food.

Food and the consumption of nutrients is important for individuals. Modern society has made it easy to gather and consume food and one of the downfalls is adding extra pounds to the human frame in the form of fat. The ease of obtaining excess food and the lack of physical exercise is contributing to the obesity epidemic that can be observed throughout the world. Our body has evolved to be able to take plant and animal components and convert them into nutrients that the body uses to elicit various chemical reactions that are pertinent to our survival.

Digestion of food involves both mechanical, microbial, and chemical processes. It can be divided into several stages that interact with one another. The first stage is the cephalic phase in the brain. The second stage is the gastric phase in the stomach. The third phase is the intestinal phase that is carried out in the small intestine and the colon.

These mechanisms require the organs to be as effective as possible and break down the nutrients in the food into meaningful cell signaling molecules. The digestive tract has evolved so that the cells in the digestive tract have developed highly specialized functions that are in constant state of communication. This communication can be in the form of direct connections via nerves, signaling throughout the body by hormones and other signaling molecules, and/or through an intricate network of internal cellular communication referred to as cellular signaling.

There are thousands of cellular signaling pathways adapting to changing environments within the body and they ultimately control the overall physiology of a body. For a signal to be transmitted within the cell, the correct signaling molecule must contact its corresponding receptor (like a lock and key). Once the lock turns or the receptor is activated, a chain of events happens throughout the cell with the end results being a specific response. This response can be for a cell to adapt to its environment and often happens on a micro-scale within a cell.

Once the receptors are activated, other signaling molecules can become activated, which can further activate other signaling molecules (and so on). The final signaling molecule's destination is ultimately the cell nucleus and the DNA, where genes (or information sequences) are turned on or off. These genes usually tell the cell what protein to make, such as insulin to shuttle glucose into the cell. The proteins are also responsible for making energy, hormones that ‘talk’ to the brain and stomach about appetite, and enzymes that defend the cell. All of these mechanisms working together make up the body's adaptive response to nutrients from food.

These cellular signaling pathways can be altered depending on the cellular environment in the body and the nutrients available from the food. As individuals become more sedentary and metabolic rates change, the cellular signaling pathways also become more sedentary and less efficient, which can lead to metabolic syndrome and insulin resistance.

Some of these cellular signaling pathways use enteroendocrine cells (EC). EC are specialized cells specifically for the gastrointestinal (GI) tract and pancreas. They have endocrine (hormone) function, and the GI tract is littered with many types of EC cells. The EC cells also release hormones or signaling peptides to initiate digestive actions or protective responses. Microbiome in the body also play a role in these responses because of their short chain fatty acid fermentation products that act as stimuli to some of the cells. Healthy digestion needs the function and interaction of all these cell types.

One specific type of EC used in food digestion is L-cells. L-cells are specialized enteroendocrine cells found primarily in the colon, to some degree in the small intestine, and in the pancreas. L-cells also help manage glucose and insulin levels and are stimulated by by-products from microbial fermentation in the colon to produce and secrete hormones such as glucagon-like peptide-1 (GLP-1), pancreatic peptide Y (PPY), and peptide YY (PYY). These three hormones have multiple paracrine and endocrine effects.

Upon food consumption, L-cells are stimulated to express the proglucagon gene (GCG) in several organs including the pancreas, gut, and brain. Depending on the organs, the proglucagon protein is further processed by tissue-specific posttranslational mechanisms to produce other peptides.

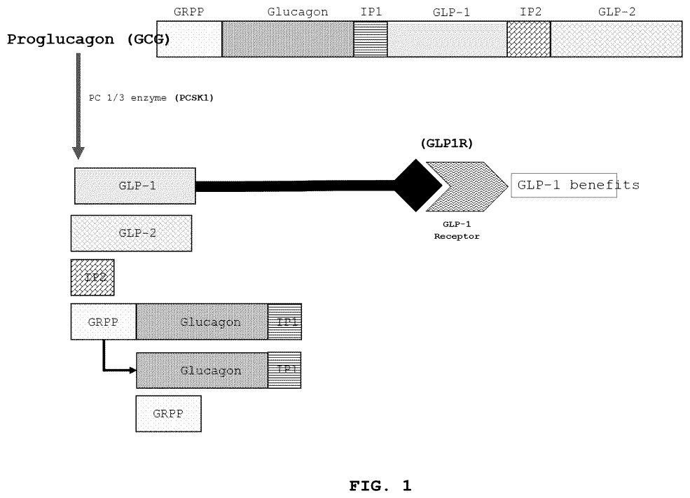

Pancreatic proglucagon can be stimulated by fasting and hypoglycemia and inhibited by insulin. It can be cleaved by prohormone convertase-2 enzyme (P/C 2) to produce glicentin-related pancreatic peptide (GRPP), glucagon, intervening peptide-1 (IP-1), and major proglucagon fragment (MPGF). Gut/brain proglucagon can also be stimulated by short-chain fatty acids, essential amino acids, sugars, and dietary fibers. As shown in FIG. 1, it can be post-translationally modified by prohormone convertase 1/3 (PC1/3) to produce glicentin-related pancreatic peptide (GRPP), oxyntomodulin, GLP-1, GLP-2, and intervening peptide-2 (IP-2).

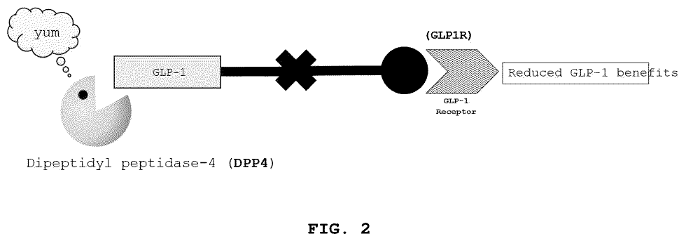

GLP-1 can be loaded into secretory vesicles within the cells and transported to the cell membrane where it is released into the hepatic portal system. Once GLP-1 is secreted, it is extremely susceptible to the proteolytic enzyme DPP-4 and only about 10-15% of secreted GLP-1 reaches the body's circulatory system. DPP-4 can also cleave GLP-1 to an inactive form, as shown in FIG. 2.

Another peptide produced by the L-cells is the peptide YY (PYY). It is closely related to the pancreatic peptide family and shows structural similarities to the pancreatic polypeptide (PPY) and neuropeptide Y (NPY). Two main forms of PYY (PYY₁₋₃₆ and PYY₃₋₃₆) are released by the L-cells upon nutrient stimulation. PYY₁₋₃₆ and PYY₃₋₃₆ differ in that the first two amino acids can be cleaved by the proteolytic DPP-4 enzyme at the N-terminal once secreted into the lumen. PYY₃₋₃₆ is highly selective to neuropeptide Y receptor type 2 (NPY2R) and is involved in the control of appetite, circadian rhythm, and anxiety.

Another peptide produced by the L-cells is pancreatic polypeptide Y (PPY). PPY is a polypeptide hormone secreted by the pancreas. It also is part of the neuropeptide Y family of peptides. Upon nutrient stimulation in the body, specialized cells in the pancreatic islets of Langerhans synthesize a pre-pro-pancreatic polypeptide which is further processed by specific posttranslational mechanisms to produce three peptides: pancreatic polypeptide (PPY), pancreatic icosapeptide, and a 5-7 amino acid-long oligopeptide. The peptides can then be secreted into the blood stream.

The GLP-1 hormone is part of the metabolic hormones called incretin. Incretins are released in response to nutrients, primarily glucose and fats and elicit an insulin response. GLP-1 has a short half-life of about 1-2 minutes once released into the hepatic portal system due to its breakdown by DPP-4. It can cross the blood/brain barrier by simple diffusion. Some GLP-1 is also produced in the brain. GLP-1 binds to the GLP-1 receptor GLP1R which is expressed in a variety of tissues such as pancreas, heart, kidneys, stomach, intestines, pituitary, hypothalamus, and Vagus nerve, thereby eliciting various chemical signaling processes. The GLP-1 hormone has several important functions. GLP-1 enhances the secretion of insulin from pancreatic beta-cells as a response to increased blood glucose levels and this enhances glucose-dependent insulin secretion. GLP-1 also suppresses glucagon secretion from pancreatic cells, further reducing glucose production in the liver. Further, GLP-1 delays gastric emptying of the stomach, which helps reduce postprandial blood glucose spikes. As well, GLP-1 interacts with central nervous system receptors to promote feelings of fullness and reducing appetite.

A related hormone, the PYY hormone, has an anorectic (loss of appetite) function in the body and plays a significant role in regulating appetite and food intake, including the following functions. PYY crosses the blood/brain barrier and directly interacts with the Y2 receptor in the brain. Through this interaction, it modulates the release of neurotransmitters involved in appetite regulation. PYY is released from the intestine in response to food intake, especially fats and proteins. It then binds to brain hypothalamus receptors and inhibits the activity of neuron PYY which is released from the intestine in response to nutrient intake, especially fats and proteins that stimulate appetite and promotes the activity of neurons that suppress appetite. This brings about a feeling of fullness and helps regulate food intake. PYY can inhibit the secretion of ghrelin in the stomach, which contributes to its appetite-suppressing effects. PYY helps slow down the emptying of the stomach, which then promotes a feeling of fullness after a meal. PYY influences gut motility, promoting digestion and longer absorption of nutrients while contributing to the feeling of satiety.

The PPY hormone is secreted after a protein meal, during fasting, exercise, and acute hypoglycemia and is decreased by somatostatin (produced in the stomach). It regulates pancreatic secretion activities through endocrine and exocrine tissue and overlaps in function with PYY. PPY works through the Vagus nerve, the nerve that connects the digestive tract to the brain, which allows it to send signals about hunger and satiety by the following mechanisms. PPY reduces the secretion of digestive enzymes and bicarbonate from the pancreas and thus regulates digestive processes. PPY acts on specific receptors in both the gut and brain, influencing the activity of other hormones and neurotransmitters involved in appetite and digestion. PPY signals the brain, especially the hypothalamus, to reduce food intake and appetite. PPY helps slow down the emptying of the stomach, which then promotes a feeling of fullness after a meal. PPY influences gut motility promoting digestion and longer absorption of nutrients while contributing to the feeling of satiety.

There are other hormones that work with GLP-1, PPY, and PYY to maintain balance and regulate food intake in the human body. As individuals consume food, signals from both hunger hormones and satiety hormones show an intricate play with the hypothalamus and other organs. Signals modulate food intake and energy expenditure to balance energy storage at the right levels for the right environmental conditions. Any change in this balance can lead to disorders, including type 2 diabetes, metabolic syndrome, and obesity.

When these hormones are out of balance, the conditions and disorders shown in Table 1 can occur.

TABLE 1

| Condition | Cause |
|---|---|
| Weight Gain | Increased levels of hunger hormones (like ghrelin) |
| | or decreased levels of satiety hormones (like leptin) |
| | can lead to overeating and weight gain. |
| Weight Loss | Conversely, excessive levels of satiety hormones |
| | or decreased hunger hormones can lead to reduced |
| | appetite and unintentional weight loss. |
| Metabolic | Imbalances can contribute to insulin resistance |
| Disorders | and increase the risk of type 2 diabetes. |
| Mood Changes | Hormonal imbalances can affect mood and lead to |
| | anxiety or depression, which can further impact |
| | eating behaviors. |
| Gastrointestinal | Altered hormone levels can affect digestion and |
| Issues | gut motility, potentially leading to issues like |
| | bloating or constipation. |
| Increased Cravings | Imbalances can lead to specific cravings, |
| | particularly for high-calorie or sugary foods. |
| Disrupted Eating | Hormonal imbalances may lead to irregular eating |
| Patterns | habits, such as binge eating or skipping meals. |

When the GLP-1 hormone is out of balance, it can lead to the various health issues shown in Table 2.

TABLE 2

| Condition | Cause |
|---|---|
| Insulin Resistance | Low levels of GLP-1 can contribute to insulin |
| | resistance, increasing the risk of type 2 |
| | diabetes. |
| Weight Gain | Insufficient GLP-1 can impair appetite |
| | regulation, leading to overeating and weight |
| | gain. |
| Glycemic Control | Abnormal GLP-1 levels can disrupt glucose |
| Issues | homeostasis, resulting in poor blood sugar |
| | control. |
| Gastrointestinal | GLP-1 plays a role in gut motility; an |
| Problems | imbalance may lead to digestive issues, such |
| | as slow gastric emptying or gastroparesis. |
| Increased Risk of | Since GLP-1 has protective cardiovascular |
| Cardiovascular | effects, low levels may heighten the risk |
| Issues | of heart disease. |

As evident from Table 2, low levels of GLP-1 hormone can contribute greatly to these health problems. There are several risk factors that can increase the risk of reduced GLP-1 production in the gut, but maintaining a healthy lifestyle can help support balanced GLP-1 production and levels. These risks factors include a hormonal imbalance, medications (especially those affecting glucose metabolism), gut health such as dysbiosis or other gastrointestinal issues, obesity with excess visceral fat, a diet low in fiber or high in fat, a sedentary lifestyle, type 2 diabetes, and aging.

One pathway to regulate the GLP-1 and associated hormones is through nutrigenomics. Nutrigenomics studies how foods and individual nutrients can affect gene expression and how genes can also affect food metabolism. Nutrigenomics has shown that nutrients can be added into the digestive system to basically reawaken those cellular signaling pathways.

The compositions described herein use the nutrigenomic mechanisms to impact expression of specific genes. They have been specifically formulated from nutrients in selected ratios to maximize the support of the body's natural cellular functions by targeting specific genetic and cellular signaling and biochemical pathways related to glucose response, appetite control, and fatty acid production by the microbiome. These compositions include the following three compositions: a MB Core™ composition, a MB Enhance™ composition, and a MindBody GLP-1 System™ composition which combines the MB Core™ and MB Enhance™ compositions.

The first composition (MB Core™) was designed with a specific number of ingredients in the ratios that target L-cells throughout the intestinal tract. The MB Core™ composition stimulates GLP-1 production in L-cells and brings these cells to an optimum state of readiness when the body is in need of a healthy insulin/glucose response and influences energy homeostasis in the hypothalamus to regulate appetite. The second composition (MB Enhance™) was designed to target the microbiome in the colon. The microbiome is responsible for creating the correct types of fuel for L-cells. It does this by creating short-chain fatty acids from the resistant starches obtained from MB Enhance™ and thus optimizing the environment in the colon to facilitate microbial metabolism of butyrogenic bacteria. Both the MB Core™ and MB Enhance™ compositions were formulated to be combined into the MindBody GLP-1 System™ composition and regulate both gut specific L-cells and neuronal brain pathways involved in appetite regulation.

In some embodiments, the MB Core™ composition contains hydrolyzed acacia gum, lemon bioflavonoids, chromium, berberine, and hesperidin. In other embodiments, the MB Core™ composition can also contain honeysuckle (Lonicera japonica) flower, yerba mate (Ilex paraguariensis) leaf, matcha (Camelia sinensis) leaf, eggplant (Solanum melongena L.) whole vegetable, microcrystalline cellulose, and stearic acid.

The MB Core™ composition contains specific amounts of hydrolyzed acacia gum. This ingredient is contained in the MB Core™ composition because it decreases the enzyme (DPP-4) that breaks down GLP-1. In some formulations, about 0.1 to about 5000 mg of this ingredient is present in the MB Core™ composition, or about 0.018 to about 89.865 wt %. In other formulations, about 50 to about 2000 mg of this ingredient is present in the MB Core™ composition, or about 8.145 to about 78.007 wt %. In yet other formulations, the MB Core™ composition contains about 63.967 wt % of this ingredient, or about 1000 mg when the MB Core™ composition weighs about 1815 mg.

The MB Core™ composition also contains specific amounts of lemon bioflavonoids. This ingredient is contained in the MB Core™ composition because it increases GLP-1 production in the blood. In some formulations, about 0.1 to about 2000 mg of this ingredient is present in the MB Core™ composition, or about 0.007 to about 59.455 wt %. In other formulations, about 50 to about 500 mg of this ingredient is present in the MB Core™ composition, or about 3.536 to about 26.834 wt %. In yet other formulations, the MB Core™ composition contains about 12.793 wt % of this ingredient, or about 200 when the MB Core™ composition weighs about 1815 mg.

The MB Core™ composition also contains specific amounts of chromium. This ingredient is contained in the MB Core™ composition because it is a mineral involved in insulin regulation. In some formulations, about 0.01 to about 0.5 mg of this ingredient is present in the MB Core™ composition, or about 0.007 to about 0.341 wt %. In other formulations, about 0.01 to about 0.250 mg of this ingredient is present in the MB Core™ composition, or about 0.007 to about 0.171 wt %. In yet other formulations, the MB Core™ composition contains about 0.137 wt % of this ingredient, or about 0.2 mg when the MB Core™ composition weighs about 1815 mg.

The MB Core™ composition also contains specific amounts of Berberine HCl (Berberis aristate). This ingredient is contained in the MB Core™ composition because it influences hunger hormones such as CCK (cholecystokinin), leptin, ghrelin, and neuropeptides. In some formulations, about 0.1 to about 1000 mg of this ingredient is present in the MB Core™ composition, or about 0.007 to about 41.383 wt %. In other formulations, about 50 to about 500 mg of this ingredient is present in the MB Core™ composition, or about 3.410 to about 26.090 wt %. In yet other formulations, the MB Core™ composition contains about 6.594 wt % of this ingredient, or about 100 mg when the MB Core™ composition weighs about 1815 mg.

The MB Core™ composition also contains specific amounts of Hesperidin. This ingredient is contained in the MB Core™ composition because it influences hunger hormones such as CCK, leptin, ghrelin, and neuropeptides. In some formulations, about 0.1 to about 1000 mg of this ingredient is present in the MB Core™ composition, or about 0.008 to about 43.346 wt %. In other formulations, about 50 to about 1000 mg of this ingredient is present in the MB Core™ composition, or about 3.685 to about 43.346 wt %. In yet other formulations, the MB Core™ composition contains about 7.107 wt % of this ingredient, or about 100 mg when the MB Core™ composition weighs about 1815 mg.

The MB Core™ composition can contain Honeysuckle (Lonicera japonica) flower in some formulations. This ingredient is contained in the MB Core™ composition because it influences hunger hormones such as CCK, leptin, ghrelin, and neuropeptides. In some formulations, about 0.1 to about 1000 mg of this ingredient is present in the MB Core™ composition, or up to about 39.164 wt %. In other formulations, about 5 to about 500 mg of this ingredient is present in the MB Core™ composition, or about 0.321 to about 24.351 wt %. In yet other formulations, the MB Core™ composition contains about 0.64 wt % of this ingredient, or about 10 mg when the MB Core™ composition weighs about 1815 mg.

The MB Core™ composition can contain yerba mate (Ilex paraguariensis) leaf in some formulations. This ingredient is contained in the MB Core™ composition because it also influences hunger hormones such as CCK, leptin, ghrelin, and neuropeptides. In some formulations, about 0.1 to about 1000 mg of this ingredient is present in the MB Core™ composition, or up to about 39.164 wt %. In other formulations, about 5 to about 500 mg of this ingredient is present in the MB Core™ composition, or about 0.321 to about 24.351 wt %. In yet other formulations, the MB Core™ composition contains about 0.64 wt % of this ingredient, or about 10 mg, when the MB Core™ composition weighs about 1815 mg.

The MB Core™ composition can contain Matcha (Camelia sinensis) leaf in some formulations. This ingredient is contained in the MB Core™ composition because it influences hunger hormones such as CCK, leptin, ghrelin, and neuropeptides. In some formulations, about 0.1 to about 1000 mg of this ingredient is present in the MB Core™ composition, or up to about 39.164 wt %. In other formulations, about 5 to about 500 mg of this ingredient is present, in the MB Core™ composition, or about 0.321 to about 24.351 wt %. In yet other formulations, the MB Core™ composition contains about 0.64 wt % of this ingredient, or about 10 mg when the MB Core™ composition weighs about 1815 mg.

The MB Core™ composition can also contain Eggplant (Solanum melongena L.) whole vegetable in some formulations. This ingredient is contained in the MB Core™ composition because it influences hunger hormones such as CCK, leptin, ghrelin, and neuropeptides. In some formulations, about 0.1 to about 1000 mg of this ingredient is present in the MB Core™ composition, or up to about 39.164 wt %. In other formulations, about 5 to about 500 mg of this ingredient is present in the MB Core™ composition, or about 0.321 to about 24.351 wt %. In yet other formulations, the MB Core™ composition contains about 0.64 wt % of this ingredient, or about 10 mg when the MB Core™ composition weighs about 1815 mg.

The MB Core™ composition can contain microcrystalline cellulose in some formulations. This ingredient is contained in the MB Core™ composition because it is an excipient and acts as a binder and flow agent. In some formulations, about 10 to about 500 mg of this ingredient is present in the MB Core™ composition. In yet other formulations, the MB Core™ composition contains about 6.4 wt % of this ingredient, or about 100 mg when the MB Core™ composition weighs about 1815 mg.

The MB Core™ composition can contain stearic acid in some formulations. This ingredient is contained in the MB Core™ composition because it an excipient and act as a binder and flow agent. In some formulations, about 1 to about 100 mg of this ingredient is present in the MB Core™ composition. In yet other formulations, the MB Core™ composition contains about 0.448 wt % of this ingredient, or about 7 mg when the MB Core™ composition weighs about 1815 mg.

With these ingredients, the MB Core™ composition can stimulate GLP-1 production in L-cells and brings these cells to an optimum state of readiness when the body is in need of a healthy insulin/glucose response and also influences energy homeostasis in the hypothalamus to regulate appetite. The MB Enhance™ composition was formulated to target the microbiome in the colon and enhance the function of the MB Core™ composition.

In some embodiments, the MB Enhance™ composition contains flax seed oil, resistant potato starch, resistant tapioca fiber, kombucha, Bacillus coagulans, Bacillus clausii, and allulose. The MB Enhance™ composition can also contain medium chain triglycerides (MCT), baobab fruit juice, guar gum, licorice root, ginger rhizome, beta-carotene, vitamin D3, vitamin E, vitamin K1, vitamin B12, folate, biotin, calcium pantothenate, niacin, vitamin B1, riboflavin, vitamin B6, vitamin C, potassium, salt, iodine, calcium, magnesium, manganese, copper, zinc, chromium, molybdenum, selenium, and flavorings and excipients like stevia leaf extract, malic acid, fumaric acid, xanthan gum, and silicon dioxide.

The MB Enhance™ composition contains specific amounts of flax seed oil. This ingredient is contained in the MB Enhance™ composition because it is a source for the microbiome to produce short-chain fatty acids, an energy source for microbiome, and improves digestive motility. In some formulations, about 0.1 to about 10,000 mg of this ingredient is present in the MB Enhance™ composition, or about 0.0.0005 to about 33.872 wt %. In other formulations, about 500 to about 4000 mg of this ingredient is present in the MB Enhance™ composition, or about 2.497 to about 17.01 wt %. In yet other formulations, the MB Enhance™ composition contains about 10.09 wt % of this ingredient, or about 2,190 mg when the MB Enhance™ composition weighs about 21.14 g.

The MB Enhance™ composition also contains resistant potato starch. This ingredient is contained in the MB Enhance™ composition because it is a resistant starch, an energy source for microbiome in colon. In some formulations, about 0.1 to about 20,000 mg of this ingredient is present in the MB Enhance™ composition, or about 0.007 to about 58.46 wt %. In other formulations, about 1,000 to about 15,000 mg of this ingredient is present in the MB Enhance™ composition, or about 6.57 to about 51.35 wt %. In yet other formulations, the MB Enhance™ composition contains about 34.54 wt % of this ingredient, or about 7,500 mg when the MB Enhance™ composition weighs about 21.14 g. In other formulations of the MB Enhance™ composition, any amount of resistant starch having a GLP-1 boosting effect can be added based on acceptability (minimal or no side effects like bloating) and cost.

The MB Enhance™ composition also contains resistant tapioca fiber. This ingredient is contained in the MB Enhance™ composition because it is a resistant fiber, an energy source for microbiome in colon. In some formulations, about 0.1 to about 20,000 mg of this ingredient is present in the MB Enhance™ composition, or about 0.007 to about 58.46 wt %. In other formulations, about 1,000 to about 15,000 mg of this ingredient is present in the MB Enhance™ composition, or about 6.57 to about 51.35 wt %. In yet other formulations, the MB Enhance™ composition contains about 34.54 wt % of this ingredient, or about 7500 mg when the MB Enhance™ composition weighs about 21.14 g. In other formulations of the MB Enhance™ composition, any amount of resistant fiber having a GLP-1 boosting effect can be added based on acceptability (minimal or no side effects like bloating) and cost.

The MB Enhance™ composition also contains kombucha. This ingredient is contained in the MB Enhance™ composition because it is an energy source for microbiome in the whole GI tract. In some formulations, about 0.1 to about 5000 mg of this ingredient is present in the MB Enhance™ composition, or about 0.0005 to about 18.73 wt %. In other formulations, about 5 to about 500 mg of this ingredient is present in the MB Enhance™ composition, or about 0.023 to about 2.25 wt %. In yet other formulations, the MB Enhance™ composition contains about 0.092 wt % of this ingredient, or about 20 mg when the MB Enhance™ composition weighs about 21.14 g.

The MB Enhance™ composition also contains Bacillus coagulans. This ingredient is contained in the MB Enhance™ composition because it acts as a probiotic. In some formulations, about 1 to about 200 mg of this ingredient is present in the MB Enhance™ composition, or about 0.2 to about 40B CFU or about 0.005 to about 1.003 wt %. In other formulations, about 2.5 to about 50 mg of this ingredient is present in the MB Enhance™ composition, or about 0.5 to about 10B CFU or about 0.013 to about 0.253 wt %. In yet other formulations, the MB Enhance™ composition contains about 0.025 wt % of this ingredient, or about 5 mg (1B CFU) when the MB Enhance™ composition weighs about 21.14 g.

The MB Enhance™ composition also contains Bacillus clausii. This ingredient is contained in the MB Enhance™ composition because it also acts as a probiotic. In some formulations, about 1 to about 200 mg of this ingredient is present in the MB Enhance™ composition, or about 0.2 to about 40B CFU or about 0.005 to about 1.003 wt %. In other formulations, about 2.5 to about 50 mg of this ingredient is present in the MB Enhance™ composition, or about 0.5 to about 10B CFU or about 0.013 to about 0.253 wt %. In yet other formulations, the MB Enhance™ composition contains about 0.025 wt % of this ingredient, or about 5 mg (1B CFU) when the MB Enhance™ composition weighs about 21.14 g.

The MB Enhance™ composition also contains allulose. This ingredient is contained in the MB Enhance™ composition because it is a natural sweetener, increases GLP-1 production, and it assists in lowering the glycemic index of blood. In some formulations, about 50 to about 5,000 mg of this ingredient is present in the MB Enhance™ composition, or about 0.236 to about 19.15 wt %. In other formulations, about 200 to about 1000 mg of this ingredient is present in the MB Enhance™ composition, or about 0.939 to about 4.523 wt %. In yet other formulations, the MB Enhance™ composition contains about 2.777 wt % of this ingredient, or about 603 mg when the MB Enhance™ composition weighs about 21.14 g.

The MB Enhance™ composition can also contain guar gum in some formulations. This ingredient is contained in the MB Enhance™ composition because it is an energy source for microbiome in the whole GI tract. In some formulations, about 0.1 to about 2000 mg of this ingredient is present in the MB Enhance™ composition, or up to about 8.44 wt %. In other formulations, about 1 to about 500 mg of this ingredient is present in the MB Enhance™ composition, or about 0.005 to about 3.75 wt %. In yet other formulations, the MB Enhance™ composition contains about 0.094 wt % of this ingredient, or about 20 mg when the MB Enhance™ composition weighs about 21.14 g.

The MB Enhance™ composition contains medium chain triglycerides (MCT) in some formulations. This ingredient is contained in the MB Enhance™ composition because it is a source for microbiome to produce short-chain fatty acids. In some formulations, about 0.1 to about 2000 mg of this ingredient is present in the MB Enhance™ composition, or up to about 7.87 wt %. In other formulations, about 50 to about 500 mg of this ingredient is present in the MB Enhance™ composition, or about 0.231 to about 2.261 wt %. In yet other formulations, the MB Enhance™ composition contains about 0.461 wt % of this ingredient, or about 100 mg when the MB Enhance™ composition weighs about 21.14 g.

The MB Enhance™ composition can contain baobab fruit juice in some formulations. This ingredient is contained in the MB Enhance™ composition because it is an energy source for microbiome in the GI tract. In some formulations, about 0.1 to about 5000 mg of this ingredient is present in the MB Enhance™ composition, or up to about 18.75 wt %. In other formulations, about 20 to about 500 mg of this ingredient is present in the MB Enhance™ composition, or about 0.092 to about 2.255 wt %. In yet other formulations, the MB Enhance™ composition contains about 0.184 wt % of this ingredient, or about 40 mg when the MB Enhance™ composition weighs about 21.14 g.

The MB Enhance™ composition can contain licorice root extract (Glycyrrhiza glabra) in some formulations. This ingredient is contained in the MB Enhance™ composition because it helps digestive health and GI (gastrointestinal) repair. In some formulations, about 0.1 to about 1000 mg of this ingredient is present in the MB Enhance™ composition, or up to about 4.422 wt %. In other formulations, about 5 to about 500 mg of this ingredient is present in the MB Enhance™ composition, or about 0.023 to about 2.261 wt %. In yet other formulations, the MB Enhance™ composition contains about 0.461 wt % of this ingredient, or about 100 mg when the MB Enhance™ composition weighs about 21.14 g.

The MB Enhance™ composition can contain ginger (Zingiber officinale) rhizome in some formulations. This ingredient is contained in the MB Enhance™ composition because it helps with digestive health and operates as an anti-inflammatory. In some formulations, about 0.1 to about 2000 mg of this ingredient is present in the MB Enhance™ composition, or up to about 8.448 wt %. In other formulations, about 5 to about 1000 mg of this ingredient is present in the MB Enhance™ composition, or about 0.023 to about 4.410 wt %. In yet other formulations, the MB Enhance™ composition contains about 0.175 wt % of this ingredient, or about 38 mg when the MB Enhance™ composition weighs about 21.14 g.

The MB Enhance™ composition can also contain beta-carotene in some formulations. This ingredient is contained in the MB Enhance™ composition because it is a vitamin and helps maintain good health. In some formulations, about 0.01 to about 30 mg of this ingredient is present in the MB Enhance™ composition, or up to about 2.031 wt %. In other formulations, about 0.02 to about 15 mg of this ingredient is present in the MB Enhance™ composition, or about 0.001 to about 1.026 wt %. In yet other formulations, the MB Enhance™ composition contains about 0.021 wt % of this ingredient, or about 0.3 mg when the MB Enhance™ composition weighs about 21.14 g.

The MB Enhance™ composition can contain vitamin D3 in some formulations. This ingredient is contained in the MB Enhance™ composition because it is a vitamin and helps maintain good health. In some formulations, about 0.0002 to about 0.1 mg of this ingredient is present in the MB Enhance™ composition, or up to about 0.207 wt %. In other formulations, about 0.0004 to about 0.1 mg of this ingredient is present in the MB Enhance™ composition, or about 0.001 to about 0.147 wt %. In yet other formulations, the MB Enhance™ composition contains about 0.02 wt % of this ingredient, or about 0.00667 mg when the MB Enhance™ composition weighs about 21.14 g.

The MB Enhance™ composition can also contain vitamin E in some formulations. This ingredient is contained in the MB Enhance™ composition because it is a vitamin and helps maintain good health. In some formulations, about 0.15 to about 1,000 mg of this ingredient is present in the MB Enhance™ composition, or up to about 19.06 wt %. In other formulations, about 0.3 to about 75 mg of this ingredient is present in the MB Enhance™ composition, or about 0.007 to about 1.735 wt %. In yet other formulations, the MB Enhance™ composition contains about 0.118 wt % of this ingredient, or about 5 mg when the MB Enhance™ composition weighs about 21.14 g.

The MB Enhance™ composition can contain vitamin K1 in some formulations. This ingredient is contained in the MB Enhance™ composition because it is a vitamin and helps maintain good health. In some formulations, about 0.012 to about 0.6 mg of this ingredient is present in the MB Enhance™ composition, or up to about 0.331 wt %. In other formulations, about 0.024 to about 0.24 mg of this ingredient is present in the MB Enhance™ composition, or about 0.013 to about 0.132 wt %. In yet other formulations, the MB Enhance™ composition contains about 0.022 wt % of this ingredient, or about 0.04 mg when the MB Enhance™ composition weighs about 21.14 g.

The MB Enhance™ composition can contain vitamin B12 in some formulations. This ingredient is contained in the MB Enhance™ composition because it is a vitamin and helps maintain good health. In some formulations, about 0.000024 to about 48 mg of this ingredient is present in the MB Enhance™ composition, or up to about 20.97 wt %. In other formulations, about 0.000048 to about 24 mg of this ingredient is present in the MB Enhance™ composition, or about 0.00003 to about 11.71 wt %. In yet other formulations, the MB Enhance™ composition contains about 0.0004 wt % of this ingredient, or about 0.0008 mg when the MB Enhance™ composition weighs about 21.14 g.

The MB Enhance™ composition can contain folate in some formulations. This ingredient is contained in the MB Enhance™ composition because it is a vitamin and helps maintain good health. In some formulations, about 0.004 to about 4 mg of this ingredient is present in the MB Enhance™ composition, or up to about 0.032 wt %. In other formulations, about 0.008 to about 2 mg of this ingredient is present in the MB Enhance™ composition, or about 0.00006 to about 0.016 wt %. In yet other formulations, the MB Enhance™ composition contains about 0.001 wt % of this ingredient, or about 0.132 mg when the MB Enhance™ composition weighs about 21.14 g.

The MB Enhance™ composition can contain biotin in some formulations. This ingredient is contained in the MB Enhance™ composition because it is a vitamin and helps maintain good health. In some formulations, about 0.003 to about 3 mg of this ingredient is present in the MB Enhance™ composition, or up to about 1.631 wt %. In other formulations, about 0.006 to about 1.5 mg of this ingredient is present in the MB Enhance™ composition, or about 0.003 to about 0.822 wt %. In yet other formulations, the MB Enhance™ composition contains about 0.005 wt % of this ingredient, or about 0.01 mg when the MB Enhance™ composition weighs about 21.14 g.

The MB Enhance™ composition can also contain riboflavin in some formulations. This ingredient is contained in the MB Enhance™ composition because it is a vitamin and helps maintain good health. In some formulations, about 0.013 to about 130 mg of this ingredient is present in the MB Enhance™ composition, or up to about 0.137 wt %. In other formulations, about 0.026 to about 13 mg of this ingredient is present in the MB Enhance™ composition, or about 0.0002 to about 0.079 wt %. In yet other formulations, the MB Enhance™ composition contains about 0.003 wt % of this ingredient, or about 0.43 mg when the MB Enhance™ composition weighs about 21.14 g.

The MB Enhance™ composition can contain calcium pantothenate in some formulations. This ingredient is contained in the MB Enhance™ composition because it is a vitamin and helps maintain good health. In some formulations, about 0.05 to about 500 mg of this ingredient is present in the MB Enhance™ composition, or up to about 2.768 wt %. In other formulations, about 0.1 to about 250 mg of this ingredient is present in the MB Enhance™ composition, or about 0.0006 to about 1.403 wt %. In yet other formulations, the MB Enhance™ composition contains about 0.01 wt % of this ingredient, or about 1.67 mg when the MB Enhance™ composition weighs about 21.14 g.

The MB Enhance™ composition can contain niacin in some formulations. This ingredient is contained in the MB Enhance™ composition because it is a vitamin and helps maintain good health. In some formulations, about 0.16 to about 50 mg of this ingredient is present in the MB Enhance™ composition, or up to about 0.348 wt %. In other formulations, about 0.32 to about 25 mg of this ingredient is present in the MB Enhance™ composition, or about 0.002 to about 0.174 wt %. In yet other formulations, the MB Enhance™ composition contains about 0.038 wt % of this ingredient, or about 5.5 mg when the MB Enhance™ composition weighs about 21.14 g.

The MB Enhance™ composition can contain vitamin B1 in some formulations. This ingredient is contained in the MB Enhance™ composition because it is a vitamin and helps maintain good health. In some formulations, about 0.012 to about 120 mg of this ingredient is present in the MB Enhance™ composition, or up to about 0.802 wt %. In other formulations, about 0.024 to about 12 mg of this ingredient is present in the MB Enhance™ composition, or about 0.0002 to about 0.081 wt %. In yet other formulations, the MB Enhance™ composition contains about 0.003 wt % of this ingredient, or about 0.4 mg when the MB Enhance™ composition weighs about 21.14 g.

The MB Enhance™ composition can contain vitamin B6 in some formulations. This ingredient is contained in the MB Enhance™ composition because it is a vitamin and helps maintain good health. In some formulations, about 0.017 to about 1700 mg of this ingredient is present in the MB Enhance™ composition, or up to about 11.42 wt %. In other formulations, about 0.034 to about 17 mg of this ingredient is present in the MB Enhance™ composition, or about 0.0003 to about 0.129 wt %. In yet other formulations, the MB Enhance™ composition contains about 0.004 wt % of this ingredient, or about 0.57 mg when the MB Enhance™ composition weighs about 21.14 g.

The MB Enhance™ composition can contain vitamin C in some formulations. This ingredient is contained in the MB Enhance™ composition because it is a vitamin and helps maintain good health, as well as acting as an antioxidant. In some formulations, about 0.9 to about 7000 mg of this ingredient is present in the MB Enhance™ composition, or up to about 1.89 wt %. In other formulations, about 1.8 to about 20000 mg of this ingredient is present in the MB Enhance™ composition, or about 0.012 to about 11.80 wt %. In yet other formulations, the MB Enhance™ composition contains about 0.665 wt % of this ingredient, or about 100 mg when the MB Enhance™ composition weighs about 21.14 g.

The MB Enhance™ composition can contain potassium in some formulations. This ingredient is contained in the MB Enhance™ composition because it is a mineral and helps maintain good health. In some formulations, about 1 to about 9400 mg of this ingredient is present in the MB Enhance™ composition, or up to about 56.13 wt %. In other formulations, about 2 to about 4700 mg of this ingredient is present in the MB Enhance™ composition, or about 0.027 to about 39.02 wt %. In yet other formulations, the MB Enhance™ composition contains about 0.217 wt % of this ingredient, or about 40 mg when the MB Enhance™ composition weighs about 21.14 g.

The MB Enhance™ composition can contain sodium in some formulations. This ingredient is contained in the MB Enhance™ composition because it adds flavor and as a mineral contributes to the general health of individuals. In some formulations, about 100 to about 1000 mg of this ingredient is present in the MB Enhance™ composition. In other formulations, the MB Enhance™ composition contains about 1.972 wt % of this ingredient, or about 428.24 mg when the MB Enhance™ composition weighs about 21.14 g.

The MB Enhance™ composition can contain iodine in some formulations. This ingredient is contained in the MB Enhance™ composition because as a mineral, it contributes to the general health of individuals. In some formulations, about 0.0015 to about 1.1 mg of this ingredient is present in the MB Enhance™ composition, or up to about 0.121 wt %. In other formulations, about 0.003 to about 0.55 mg of this ingredient is present in the MB Enhance™ composition, or about 0.0003 to about 0.061 wt %. In yet other formulations, the MB Enhance™ composition contains about 0.005 wt % of this ingredient, or about 0.05 mg when the MB Enhance™ composition weighs about 21.14 g.

The MB Enhance™ composition can contain calcium in some formulations. This ingredient is contained in the MB Enhance™ composition because as a mineral, it contributes to the general health of individuals. In some formulations, about 13 to about 2000 mg of this ingredient is present in the MB Enhance™ composition, or about 0.309 to about 32.32 wt %. In other formulations, about 26 to about 1300 mg of this ingredient is present in the MB Enhance™ composition, or about 0.617 to about 23.68 wt %. In yet other formulations, the MB Enhance™ composition contains about 1.185 wt % of this ingredient, or about 50.245 mg when the MB Enhance™ composition weighs about 21.14 g.

The MB Enhance™ composition can contain magnesium in some formulations. This ingredient is contained in the MB Enhance™ composition because as a mineral, it contributes to the general health of individuals. In some formulations, about 0.4 to about 700 mg of this ingredient is present in the MB Enhance™ composition or up about 16.78 wt %. In other formulations, about 0.8 to about 420 mg of this ingredient is present in the MB Enhance™ composition, or about 0.023 to about 10.79 wt %. In yet other formulations, the MB Enhance™ composition contains about 1.2 wt % of this ingredient, or about 43.33 mg when the MB Enhance™ composition weighs about 21.14 g.

The MB Enhance™ composition can contain manganese in some formulations. This ingredient is contained in the MB Enhance™ composition because as a mineral, it contributes to the general health of individuals. In some formulations, about 0.023 to about 11 mg of this ingredient is present in the MB Enhance™ composition or up about 0.271 wt %. In other formulations, about 0.046 to about 6.5 mg of this ingredient is present in the MB Enhance™ composition, or about 0.001 to about 0.160 wt %. In yet other formulations, the MB Enhance™ composition contains about 0.02 wt % of this ingredient, or about 0.8 mg when the MB Enhance™ composition weighs about 21.14 g.

The MB Enhance™ composition can contain copper in some formulations. This ingredient is contained in the MB Enhance™ composition because as a mineral, it contributes to the general health of individuals. In some formulations, about 0.009 to about 10 mg of this ingredient is present in the MB Enhance™ composition, or up to about 0.406 wt %. In other formulations, about 0.018 to about 4.5 mg of this ingredient is present in the MB Enhance™ composition, or about 0.0007 to about 0.183 wt %. In yet other formulations, the MB Enhance™ composition contains about 0.012 wt % of this ingredient, or about 0.3 mg when the MB Enhance™ composition weighs about 21.14 g.

The MB Enhance™ composition can contain zinc in some formulations. This ingredient is contained in the MB Enhance™ composition because as a mineral, it contributes to the general health of individuals. In some formulations, about 0.1 to about 40 mg of this ingredient is present in the MB Enhance™ composition, or up to about 0.796 wt %. In other formulations, about 0.2 to about 33 mg of this ingredient is present in the MB Enhance™ composition, or about 0.0040 to about 0.658 wt %. In yet other formulations, the MB Enhance™ composition contains about 0.080 wt % of this ingredient, or about 4 mg when the MB Enhance™ composition weighs about 21.14 g.

The MB Enhance™ composition can contain chromium in some formulations. This ingredient is contained in the MB Enhance™ composition because it is a mineral and involved in insulin regulation. In some formulations, about 0.01 to about 0.5 mg of this ingredient is present in the MB Enhance™ composition, or up to about 0.0297 wt %. In other formulations, about 0.01 to about 0.25 mg of this ingredient is present in the MB Enhance™ composition, or about 0.0006 to about 0.015 wt %. In yet other formulations, the MB Enhance™ composition contains about 0.0007 wt % of this ingredient, or about 0.012 mg when the MB Enhance™ composition weighs about 21.14 g.

The MB Enhance™ composition can contain molybdenum in some formulations. This ingredient is contained in the MB Enhance™ composition because as a mineral, it contributes to the general health of individuals. In some formulations, about 0.00045 to about 2 mg of this ingredient is present in the MB Enhance™ composition, or up to about 0.721 wt %. In other formulations, about 0.0009 to about 0.45 mg of this ingredient is present in the MB Enhance™ composition, or up to about 0.163 wt %. In yet other formulations, the MB Enhance™ composition contains about 0.005 wt % of this ingredient, or about 0.015 mg when the MB Enhance™ composition weighs about 21.14 g.

The MB Enhance™ composition can contain selenium in some formulations. This ingredient is contained in the MB Enhance™ composition because as a mineral, it contributes to the general health of individuals. In some formulations, about 0.00055 to about 0.4 mg of this ingredient is present in the MB Enhance™ composition, or up to about 0.230 wt %. In other formulations, about 0.0011 to about 0.275 mg of this ingredient is present in the MB Enhance™ composition, or up to about 0.158 wt %. In yet other formulations, the MB Enhance™ composition contains about 0.010 wt % of this ingredient, or about 0.018 mg when the MB Enhance™ composition weighs about 21.14 g.

The MB Enhance™ composition can contain stevia leaf extract in some embodiments. This ingredient is contained in the MB Enhance™ composition because it is a sweetener and adds flavor. In some formulations, about 100 to about 500 mg of this ingredient is present in the MB Enhance™ composition. In yet other formulations, the MB Enhance™ composition contains about 0.861 wt % of this ingredient, or about 187 mg when the MB Enhance™ composition weighs about 21.14 g.

The MB Enhance™ composition can contain malic acid in some formulations. This ingredient is contained in the MB Enhance™ composition because it adds flavor. In some formulations, about 100 to about 500 mg of this ingredient is present in the MB Enhance™ composition. In yet other formulations, the MB Enhance™ composition contains about 0.654 wt % of this ingredient, or about 142 mg when the MB Enhance™ composition weighs about 21.14 g.

The MB Enhance™ composition can contain fumaric acid in some formulations. This ingredient is contained in the MB Enhance™ composition because it adds flavor to the composition. In some formulations, about 1 to about 25 mg of this ingredient is present in the MB Enhance™ composition. In other formulations, the MB Enhance™ composition contains about 0.046 wt % of this ingredient, or about 10 mg when the MB Enhance™ composition weighs about 21.14 g.

The MB Enhance™ composition can contain any mix of natural flavors in some formulations. In some formulations, about 500 to about 5,000 mg of this ingredient is present in the MB Enhance™ composition. In other formulations, the MB Enhance™ composition contains about 7.434 wt % of this ingredient, or about 1,614 mg when the MB Enhance™ composition weighs about 21.14 g.

The MB Enhance™ composition can contain xanthan gum in some formulations. This ingredient is contained in the MB Enhance™ composition because it adds texture to the composition. In some formulations, about 100 to about 1,000 mg of this ingredient is present in the MB Enhance™ composition. In other formulations, the MB Enhance™ composition contains about 1.359 wt % of this ingredient, or about 295 mg when the MB Enhance™ composition weighs about 21.14 g.

The MB Enhance™ composition can contain silicon dioxide in some formulations. This ingredient is contained in the MB Enhance™ composition because it serves as an excipient, a flow agent, and/or a desiccant. In some formulations, about 10 to about 500 mg of this ingredient is present in the MB Enhance™ composition. In other formulations, the MB Enhance™ composition contains about 0.530 wt % of this ingredient, or about 115 mg when the MB Enhance™ composition weighs about 21.14 g.

In some embodiments, the following compounds that are GLP-1 receptor agonists could be used in place of, or in addition to, the GLP-1 receptor agonists that are used in the MB Core™ or MB Enhance™ compositions. These compounds include allulose, citrus fruits, Curcuma longa, oats, barley, legumes, omega-3 fatty acids, butyric acid, short-chain fatty acids, monounsaturated fats, green tea, Gymnema sylvestre, Trigonella foenum-graecum, bitter melon (Momordica charantia), aloe vera, mulberry, dandelion, milk thistle, Astragalus, Stevia rebaudiana, holy basil, hops and/or combinations thereof.

In other embodiments, the following compounds that are DPP-4 receptor agonists could be used in place of, or in addition to, the DPP-4 receptor agonists that are used in the MB Core™ or MB Enhance™ compositions. These compounds include Trigonella foenum-graecum, green tea, mulberry, psyllium, allulose, Stevia rebaudiana, and/or combinations thereof.

In yet other embodiments, the following compounds that activate/reduce hypothalamus appetite genes/receptors could be used in place of, or in addition to, similar compounds that are used in the MB Core™ or MB Enhance™ compositions. These compounds include green tea, psyllium, Garcinia cambogia, Hoodia gordonii, Foeniculum vulgare (fennel), holy basil, slippery elm (Ulmus rubra), dandelion, Astragalus, cocoa and/or combinations thereof.

The ingredients in the MB Core™ composition can be combined to create a single serving that can range from about 1 gram to about 2 grams. In some embodiments, the single serving can range from about 1.5 grams to about 1.8 grams. In other embodiments, the serving amount depends on the types of ingredients (active ingredient, stabilizers, excipients, and encapsulators) that are included in the composition. For example, when just active ingredients are included in the composition, the MB Core™ composition can be about 1.46 grams or about 0.728 grams when it is formulated in 2 capsules. In another example, when active ingredients and excipients are included in the composition, the MB Core™ composition can be about 1.56 grams or about 0.782 grams when it is formulated in 2 capsules. In yet another example, when active ingredients and a stabilizer are included in the composition, the MB Core™ composition can be about 1.46 grams or about 0.728 grams when it is formulated in 2 capsules. In yet another example, when active ingredients, excipients, and a stabilizer are included in the composition, the MB Core™ composition can be about 1.56 grams or about 0.782 grams when it is formulated in 2 capsules. In still another example, when active ingredients, excipients, a stabilizer, and an encapsulant are included in the composition, the MB Core™ composition can be about 1.82 grams or about 0.908 grams when it is formulated in 2 capsules.

The ingredients in the MB Enhance™ composition can be combined to create a single serving that can range from about 4 grams to about 7 grams. In some embodiments, the single serving can range from about 5 grams to about 6 grams. In other embodiments, the serving amount depends on the types of ingredients (flavorings, sweeteners) and overages that are included in the composition. For example, when both flavorings/sweeteners and overages are included in the MB Enhance™ composition, the total weight is about 21.71 grams per 4 scoops or 5.428 grams per 1 scoop for single serving. In another example, when only flavorings/sweeteners and no overages are included in the MB Enhance™ composition, the total weight is about 21.62 grams per 4 scoops or 5.406 grams per 1 scoop for single serving.

The MB Core™ and MB Enhance™ compositions can be prepared in various dosage forms. In some forms, they can be prepared as a capsule or a tablet. In other forms, they can be prepared as a powder. In some configurations, the MB Core™ composition is prepared as a capsule and the MB Enhance™ composition is prepared as a powder.

In some configurations, the MB Core™ composition is formulated as follows:

In some configurations, the MB Enhance™ composition is formulated as follows:

The MB Core™ and MB Enhance™ compositions can be used together or separately to help regulate weight loss for individuals and provide the other benefits described herein. In some embodiments, the MB Core™ and MB Enhance™ compositions can be combined to create a MindBody GLP-1 System™ composition that can be given to an individual at about the same time. When combined in these embodiments, the MindBody GLP-1 System™ composition contains the ingredients and the amounts shown in Table 3.

TABLE 3

| | Amount | Weight % |
|---|---|---|
| Ingredients | (mg) | in Blend |
| Hydrolyzed acacia gum | 1,000 | 5.202048% |
| Lemon bioflavonoids | 200 | 1.040410% |
| Chromium | 0.2 | 0.001040% |
| Berberine HCl | 100 | 0.520205% |
| (Berberis aristate) | | |
| Hesperidin | 100 | 0.520205% |
| Flax Seed oil | 2,190 | 11.392484% |
| Resistant Potato Starch | 7,500 | 39.015356% |
| Resistant Tapioca Fiber | 7,500 | 39.015356% |
| Kombucha | 20 | 0.104041% |
| Bacillus coagulans | 5 | 0.026010% |
| Bacillus clausii | 5 | 0.026010% |
| Allulose | 603 | 3.136835% |

In other embodiments, the MB Core™ and MB Enhance™ compositions can be taken separately within a 24-hour period even though better results come from consuming them at about the same time.

These amounts are based on 1.82 g of the MB Core™ composition being taken at about the same time as 21.71 g of the MB Enhance™ composition by an individual. When the relative amounts of the MB Core™ composition and MB Enhance™ composition taken are modified within the ranges described herein, the relative weight percentages of these ingredients will be modified as well.

### Example 1: In-Vitro

An in-vitro study was carried out to test the effect of the compositions described herein. Cell viability assays were performed for the MB Core™ and the MB Enhance™ composition to determine if NCI-H716 cells were impacted by their ingredients and to ascertain the optimal dosage for additional studies. The viability of NCI-H716 cells were evaluated using the Cell-Titer Glow Luminescent Cell assay based on quantification of ATP Adenosine triphosphate present, as an indicator of metabolically active cells. Cells were seeded at a density of 1000 cells/well in a 384-well white-walled cell culture plates and exposed at various concentrations (400, 200, 100, 50, 25, 12, 6, and 0 mcg/mL) to the MB Core™ and MB Enhance™ compositions the following day. The cells were allowed to grow in the presence of the MB Core™ and the MB Enhance™ compositions for 24 hours for dose-course studies. After this period, a Cell-Titer-Glo (Promega Corp., Madison WI) reagent was added at a volume equal to the cell culture medium in the plate according to manufacturer's instructions. The luminescence was read on an Envision 2105 multilabel reader (Perkin-Elmer, Waltham WI).

For gene expression studies and RNA extraction, the NCI-H716 cells were seeded at 0.5×10⁶ cells per well in 6-well tissue culture wells that had been treated with Matrigel. The cells were individually exposed to the MB Core™ composition alone, the MB Enhance™ composition alone, or the MindBody GLP-1 System™ composition about 72 hours after differentiation induced by the Matrigel. At indicated time points (3 hours, 8 hours, and 24 hours), RNA was extracted with the PureLink RNA Mini Kit (Thermo-Fisher Scientific, Waltham MA) using the instructions in this kit, with the exception that cells were lysed on the plate using 600 μL of lysis buffer. RNA was eluted with 45 μL of RNAse-free water and quantified on a NanoDrop spectrophotometer from Thermo-Fisher Scientific.

Reverse transcription/quantification real-time polymerase chain reaction (qRT-PCT) was then performed using the extracted RNA. A first-strand cDNA synthesis was carried out on 0.5 μg of the RNA using the SuperScript VILO Master Mix (Thermo-Fisher Scientific) following the manufacturer's instructions. A 6-fold dilution was made of each cDNA in PCR-grade water, and 6.5 μL of this solution was carried forward into qRT-PCR. The following PCR primers in Table 4 were purchased from Thermo Fisher Scientific and used.

TABLE 4

| Symbol | Identifier | Label |
|---|---|---|
| GCG | Hs01031536_m1 | FAM |
| PPY | Hs00358111_g1 | FAM |
| GLP1R | Hs00157705_ml | FAM |
| DPP4 | Hs00897386_m1 | FAM |
| PCSK1 | Hs01026107_m1 | FAM |
| PYY | Hs00373890_g1 | FAM |
| ACTB | Hs01060665_g1 | VIC |
| | *endogenous control | |

The PCR reactions were carried out in 15 μL total volume of the following solution: 6.5 μL cDNA, 6 μL PCR-grade water, 0.5 μL gene-of-interest primer (FAM label), 0.5 μL actin primer (VIC label), and 7.5 μL Taqman Fast Advanced Master Mix (Thermo Fisher Scientific). The PCR reactions were performed using an Applied Biosystems QuantStudio Real-Time PCR Instrument (Thermo Fisher Scientific) under the following conditions: 50° C. for 2 minutes, 95° C. for 20 seconds, and then 40 cycles of 95° C. for 3 seconds and 60° C. for 30 seconds. The threshold cycle (C_{T}) was determined using the instrument software. The differences in the threshold cycle between the gene of interest and actin (ΔC_{T}) were determined for each sample and used to determine fold induction of each gene when compared to untreated controls.

The viability results were reported as follows. There was little to no difference in cell viability noted in the viability assays. It was unknown how close the highest dose of 400 μg/mL was to a dose limiting toxicity. In previous work with similar formulations, 400 μg/mL was considered on the high end of dosing.

The QPCR (Quantitative Polymerase Chain Reaction) results were reported as follows. The percent change observed for each gene target of interest using the MB Core™ and the MindBody GLP-1 System™ compositions are shown below in Table 5.

TABLE 5

| Gene target | Core | System |
|---|---|---|
| GCG (Proglucagon) | 47% | 95% |
| PCSK1 (PC ⅓ enzyme) | 23% | 32% |
| DPP4 (dipeptidyl dipeptidase 4) | −14% | −38% |
| GLP1R (GLP-1 receptor) | 0% | 53% |
| PPY (pancreatic polypeptide Y) | 137% | 1280% |
| PYY (peptide YY) | 0% | 55% |

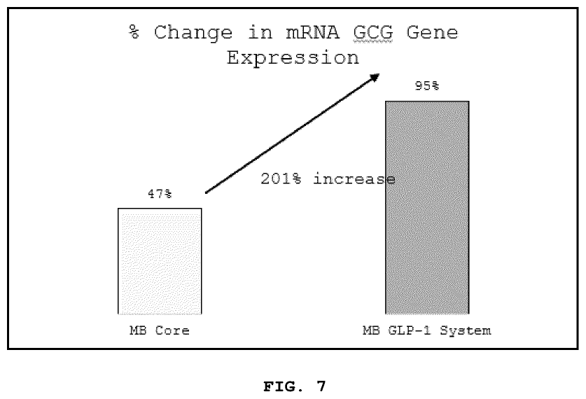

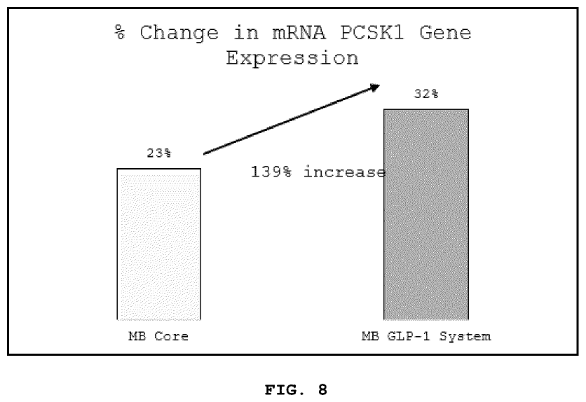

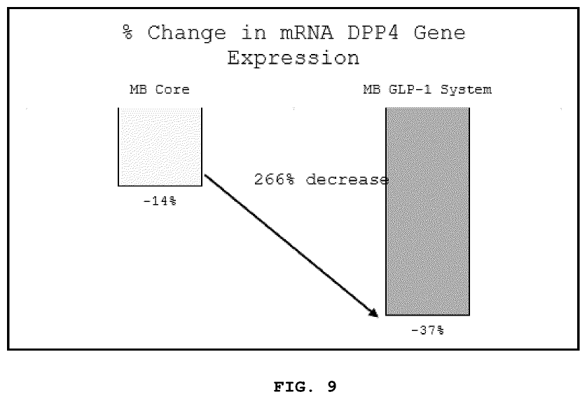

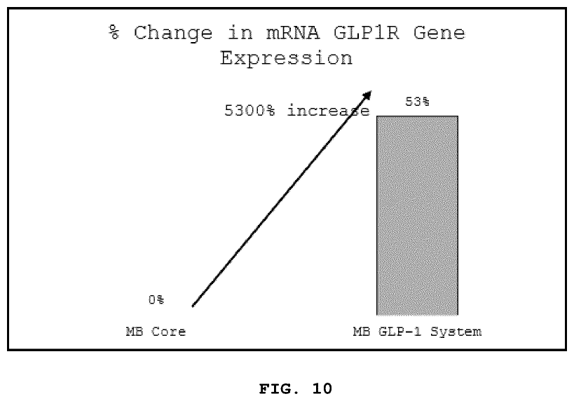

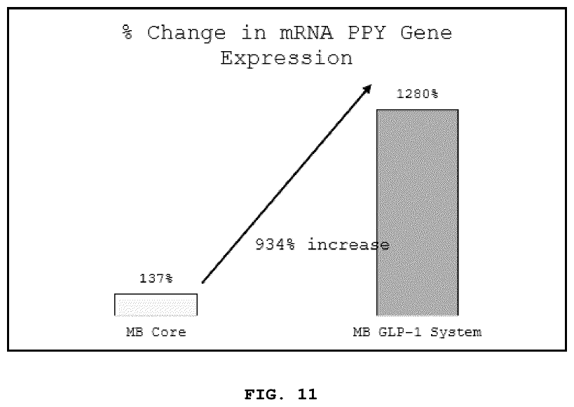

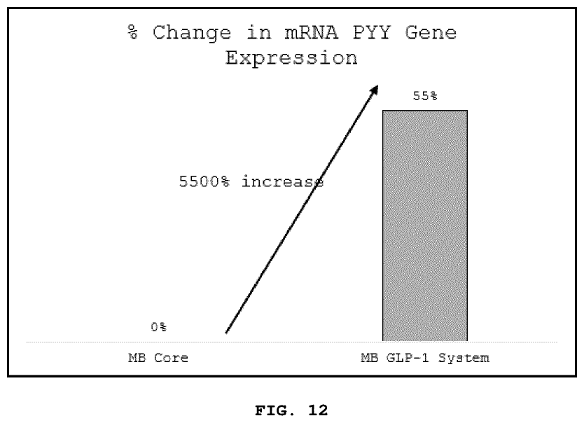

The results showed that there was both synergy and dual activation of specific genes using the MB Core™ and MB Enhance™ compositions. This result was measured by the amplification/increase in the percent change of the gene expression of interest. For example, the gene activity of GCG, which codes for a preglucagon protein, increased by 95% when treated with the MindBody GLP-1 System™ composition when compared to the MB Core™ composition alone (47%), about a 201% increase. A similar synergy was observed with PCSK1 gene (23% to 32%-about a 139% increase), the DPP4 gene (−14% to −38%-about a 266% increase), and the PPY gene (137% to 1280%-about a surprising 934% increase). The gene expressions for the GLP-1 receptor (GLP1R) and the neuropeptide PYY were minimally influenced by MB Core™ composition alone but showed synergies with the MB Enhance™ composition in light of the increase in gene expression by about 53% (about a 5300% increase) and about 55% (about 5500% increase), respectively. The gene expression increase under the MindBody GLP-1 System™ composition was higher relative to the MB Enhance™ composition alone, as shown in FIGS. 7-12, thus synergies were also observed with these two genes (GLP1R and PYY).

The amount of GLP-1 in-vitro secretion was also measured. The Human active GLP-1 (7-36) amide and GLP-1 (7-37) specific assay kit from Revvity with Homogeneous Time-Resolved Fluorescence (HTRF) technology was used to specifically look at active GLP-1 in the media and in the cells. The cells were treated with the MB Core™ composition, the MB Enhance™ composition, and a combination of the two. The assay was conducted according to manufacturer's specifications using an Envision 2105 multi-label reader that measured both 620 nm cryptate and 665 nm acceptor emissions after excitation with a 60 usec delay. The tissue culture media or cell lysate using RIPA buffer were used in the assay. Delta F ratios were calculated and used for interpolation of pro-collagen concentrations from a standard curve using any of the following normalization protocols: Prism; GraphPad; log (inhibitor) vs. response; or Variable slope.

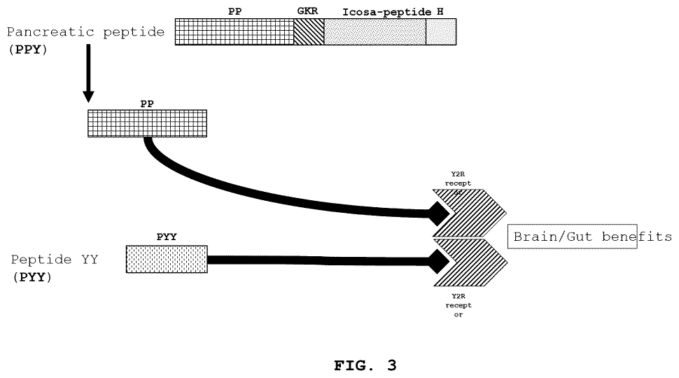

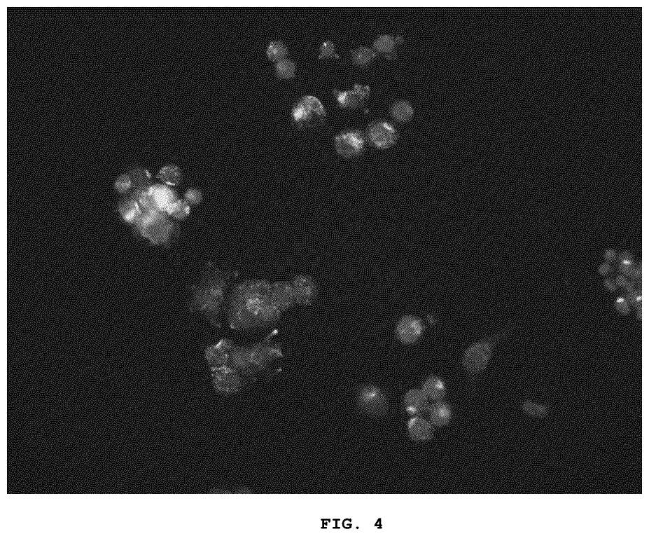

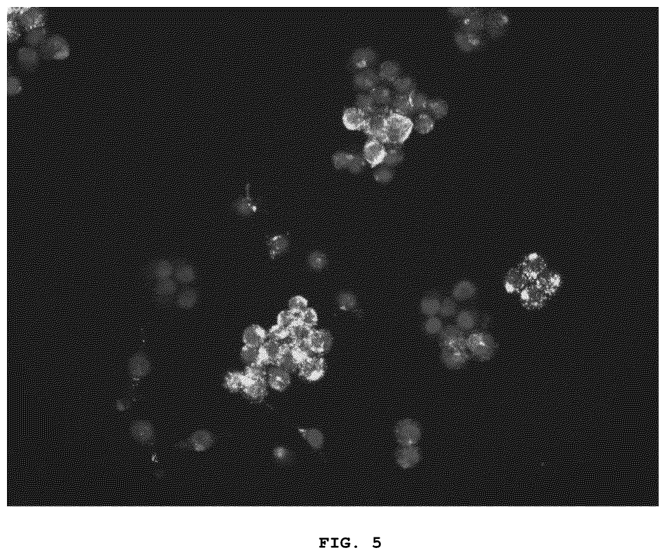

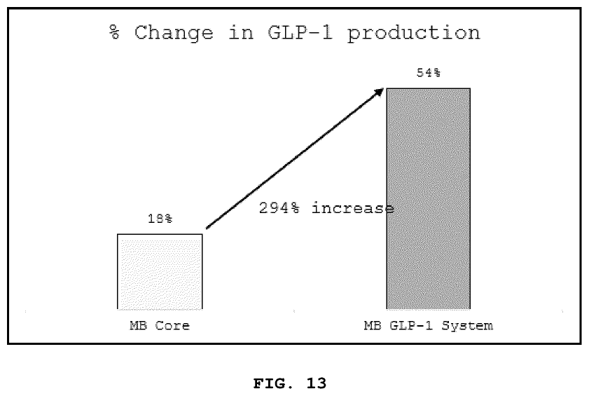

The total amount of GLP-1 protein secreted in both the cells and released into media showed a 54% increase after 48 hour incubation in the MindBody GLP-1 System™ composition. As shown in FIG. 13, this was a 294% increase when compared to the MB Core™ composition alone. The amount of GLP-1 secreted was measured by the following imaging methods. NCI-H716 cells were grown in black 96-well plates with optically clear bottoms. The cells were fixed at appropriate time points (3 hours, 8 hours, and 24 hours) using 4% paraformaldehyde in PBS (phosphate-buffered saline) with a pH of 7.4 for 10 minutes at room temperature. Any fixed cells were washed three times in ice-cold PBS and then by permeabilization with PBS with 0.2% triton X-100. The cells were then washed and blocked with staining buffer containing 1% BSA (bovine serum albumin). The cells were then incubated in diluted Antibodies Online Cat. M2-42539 (1:100) in 1% BSA in PBST (PBS+1% Tween 20) in a humidified chamber for 1 hour. The cells were next incubated with secondary antibody Goat anti-rabbit AF488 (ThermoFisher Cat #3434-050-RTU) for 30 minutes. The cells were then counter-stained with DAPI 4′,6-diamino-2-phenylindole) for 15 minutes and washed once prior to imaging on an Evos FL auto 2 imager. The images showed more accumulation of GLP-1 protein inside cells when adding the MB Core™ composition, as shown in FIG. 4, or the MindBody GLP-1 System™ composition, as shown in FIG. 5, when compared to the control image, as shown in FIG. 3.

The average changes in gene expressions in this in vitro study using the MB Core™, MB Enhance™, and MindBody GLP-1 System™ compositions are summarized in Table 6.

TABLE 6

| | Negative | Positive | | | |
|---|---|---|---|---|---|
| | Control | Control | | | |
| Gene | (Base) | (Insulin) | Core | Enhance | System |
| GCG | 1.005 ± 0.144 | 1.789 ± 0.362 | 1.478 ± 0.042 | 1.239 ± 0.237 | 1.966 ± 0.415 |
| PCSK1 | 1.000 ± 0.009 | 0.978 ± 0.171 | 1.234 ± 0.053 | 0.805 ± 0.110 | 1.322 ± 0.219 |
| DPP4 | 1.001 ± 0.066 | 0.497 ± 0.010 | 0.859 ± 0.092 | 0.851 ± 0.151 | 0.624 ± 0.008 |
| GLP1R | 1.001 ± 0.05 | 0.363 ± 0.043 | 1.000 ± 0.035 | 0.789 ± 0.136 | 1.533 ± 0.524 |
| PPY | 1.001 ± 0.074 | 1.630 ± 0.246 | 2.374 ± 0.192 | 6.258 ± 2.717 | 13.822 ± 3.584 |
| PYY | 1.000 ± 0.007 | 0.600 ± 0.013 | 1.000 ± 0.032 | 1.345 ± 0.201 | 1.549 ± 0.328 |

The average change in total GLP-1 production in this in vitro study using the MB Core™, MB Enhance™, and MindBody GLP-1 System™ compositions are shown in Table 7.

TABLE 7

| | Negative | | | |
|---|---|---|---|---|
| | Control | | | MindBody GLP-1 |
| | (Base) | MB Core ™ | MB Enhance ™ | System ™ |
| Total GLP-1 | 912.83 ± 44.47 | 1081.15 ± 68.96 | Not measured | 1408.30 ± 180.79 |
| production | | | | |

### Example 2: In-Vivo

60 participants were recruited to participate in a 12-week randomized trial and screened for inclusion and exclusion criteria. The screening consisted of a brief description of the clinical study, its importance, and the associated risk factors. This description was followed by a screening questionnaire, where eligibility criteria were reviewed and current medication, supplement regimen, and allergy inventory was taken. The inclusion and exclusion criteria for the study are listed below.

### Inclusion Criteria:

30 years or older
Willing to have before and after photos taken
BMI>25 m/kg²
Pre-diabetic condition was acceptable
If off weight loss medication for at least 3 months
Able to come into the clinic for measurements
No food allergies

### Exclusion Criteria

Pregnant or breastfeeding
Have gone through weight loss surgery
Taking weight loss drugs/diabetes drugs such as Ozempic, etc.
Taking coumadin or warfarin medications
Any active infection in the last month requiring antibiotics, anti-viral medication or hospitalization
Use of immunosuppressive drugs in the last 12 months (including biologics and steroids)
History of seizure, seizure medication taken in the last 4 weeks
Hyperthyroidism or hypothyroidism
Known allergy or sensitivity to herbal products
History of HIV or solid organ transplant
Medication for chronic diseases such as: diabetes, asthma, uncontrolled blood pressure (i.e. medications have been adjusted over the last 4 weeks)

After the participants were deemed eligible, they were randomized into one of the following three groups.
1. Control (PG) group, no products or educational sessions were provided. This was done to obtain a sense of the normalization curve in the population recruited, regarding GLP-1 concentration, weight, and other biometrics. (n=10)
2. Product Group 1 (CG) received the MB Core™ composition, the MB Enhance™ composition, and a commercial protein powder with instructions on how to consume them. (n=25)
3. Product Group 2 (TG) received the MB Core™ composition, the MB Enhance™ composition, a commercial protein powder and some educational information on diet, exercise, and calorie recommendations. (n=25)

50% males and 50% females were recruited in the clinical study. The baseline ages ranged from 31-78 years (average of 50.2±10.6 years), the weights ranged from 154-467 pounds, the waist circumferences ranged from 33.2-67 inches, the body fat (%) ranged between 20.7-63.4%, and the subcutaneous (%) and visceral fat ranged from 15.4-54.2% and 7-27 pounds, respectively. The skeletal muscle (%) and muscle mass ranged from 21.2-53.2% and 86.0-164.2 pounds, respectively. There were no statistical differences between the groups in light of the baseline and biometric measurements as summarized in Table 8.

TABLE 8

| Biometrics (Baseline) | Ranges | |
|---|---|---|
| Weight (lbs) | 154-467 | lbs |
| Waist circumference (in) | 33.2-67 | in |
| Body fat % | 20.7-63.4% | |
| Subcutaneous fat (%) | 15.4-54.2% | |
| Visceral fat (lbs) | 7-27 | lbs |
| Skeletal muscle (%) | 21.2-53.2% | |
| Muscle mass (%) | 86.0-64.2 | lbs |

At selected time points throughout the study (baseline, week 4, week 8, and week 12) each group arrived at the testing facility in the mornings between 7-9 am. All participants arrived at the testing facility in an overnight fasting state. Blood samples for GLP-1 analysis and fasting glucose were taken, anthropometric/biometric measurements using a Renpho scale were taken, before/after pictures were obtained, and subjective questionnaires of their food behavior and cravings were completed. Each subject was instructed to take 2 capsules (1 serving) of the MB Core™ composition with a glass of water at least 30 minutes before their first meal. Subjects were asked to take 4 scoops of the MB Enhance™ composition mixed into a 26 g protein shake as their first meal of the day. The first study week subjects took 1 serving of the MB Core™ composition and 2 scoops (½ serving) of the MB Enhance™ composition to get used to the extra fiber in their diet and then it was increased it to 4 scoops (1 serving) for the duration of the study.

The anthropometric and biometric measurements were obtained using the following procedure. At each time point (baseline, week 4, week 8, and week 12), a participant was asked to step onto a Renpho scale (ES-30M or ES-CS20M model) that was connected to the Renpho Health app via bluetooth. The scale used impedance (resistance of electrical flow through the body) to measure biometric parameters. Muscle contains more water than fat and conducts electricity better, allowing the scale to estimate body fat percentage based on resistance. A Renpho tape measure (ES Tape) was also connected via Bluetooth to the Renpho Health app and waist circumferences were measured at each time point. The following parameters were measured:
Weight (lbs or kgs)
BMI (kg/m²)
Body fat (%)
Fat-Free-mass (lbs)
Subcutaneous fat (%)
Visceral fat
Body water (%)
Skeletal muscle (%)
Muscle mass (%)
Bone mass (lbs, %)
Protein (%)
Basal metabolic rate (BMR, kcal)
Metabolic age (yrs)

Pictures of each individual were also obtained. At each time point, each individual had a picture taken from the side and from the front, in the same location and under the same conditions. Individuals were asked to wear the same or similar clothing. A questionnaire was completed at each time point by each participant in the study. This questionnaire asked about food behavior and cravings between the study time points.

Blood samples for GLP-1 and fasting glucose levels were also obtained at each time point. The fasting blood samples were obtained using specialized tubes (Becton Dickenson BD800 tubes containing spray-dried K2EDTA anti-coagulant that contains DPP-4 and other protease inhibitor cocktails) that collected at least 2 mL of venous blood and transported it to a certified lab to analyze for GLP-1 concentration. These blood samples were then used to analyze the plasma metabolic markers glucagon-like peptide-1 (GLP-1). The blood samples were prepared using the following procedure. The samples were centrifuged at 1,000-1,300 rpm using a swing out rotor centrifuge for 10-20 minutes and separated into plasma and red blood cells. Aliquots of plasma were then frozen and stored at ≤70° Celsius until further analyzed. All samples were thawed and prepared according to manufacturer specifications. A GLP-1 Active Kit (Mesoscale, K1503OD-2; www.mesoscale.com) was used to analyze the GLP-1 concentrations for each individual. The fasting glucose for each individual was measured using a commercially available portable blood glucose meter and test strips.

There were no significant differences between the two groups (CG and TG) in any of the measured parameters and so their results were presented together. Diet and exercise recommendations appeared to play no significant role in the study.

At the end of the study at 12 weeks, there was an average loss of about 11 pounds with a high of about 25 pounds, with 1 in 4 participants losing more than about 15 pounds. One subject lost up to 11% of total body weight over the study period, with a 5.5% decrease of body fat, a 4.4% decrease in subcutaneous fat, and an astounding 27% decrease in visceral fat. All participants who lost weight maintained or increased their skeletal muscle percentage over 12 weeks. Other measured results at the end of the study are summarized in Table 9.

TABLE 9

| Biometrics | % Responders* |
|---|---|
| Weight (lbs) | 92% (up to 25 lbs decreased, average 11 lbs |
| | decrease) |
| Body Fat (%) | 92% (up to 5.5% decrease, average 2% decrease) |
| Subcutaneous Fat | 91% (up to 4.4% decrease, average 2% decrease) |
| (%) | |
| Visceral Fat (lbs) | 71% (up to 27% decrease, average 15% decrease) |
| Skeletal Muscle (%) | 91% (up to 2.7% increase, average 1% increase) |

*Percentage of participants who improved in biometric parameters over the 12-week study period. Other participants did not improve or saw no changes.

The results of the questionnaires completed by the participants are presented in Table 10. The results were normalized to reflect the percentage changes in the participants' responses.

TABLE 10

| Question | CG | TG | Average |
|---|---|---|---|
| % Agreed that their food cravings | 77% | 93% | 85% |
| decreased | | | |
| % Agreed that their sugar cravings | 98% | 91% | 95% |
| decreased | | | |
| % Agreed that the amount they eat | 80% | 100% | 90% |
| at each meal decreased | | | |
| % Agreed that the portion size at | 91% | 100% | 96% |
| each meal decreased | | | |
| % Agreed that their willpower to | 87% | 42% | 65% |
| resist snacking increased throughout | | | |
| the day | | | |
| % Agreed that their energy levels | 50% | 88% | 69% |
| increased throughout the day | | | |
| % Agreed that their appetite | 85% | 85% | 85% |
| decreased | | | |
| % Agreed that their satisfaction | 60% | 85% | 73% |
| between meals increased | | | |
| % Agreed that their urge to snack | 65% | 63% | 64% |
| decreased throughout the day | | | |
| % Agreed that they eat for health | 82% | 88% | 85% |
| instead of emotional eating | | | |
| % Agreed that they have more control | 71% | 93% | 82% |
| of their relationship with food | | | |
| % Agreed that they eat just the right | 43% | 77% | 60% |
| amount for overall health | | | |

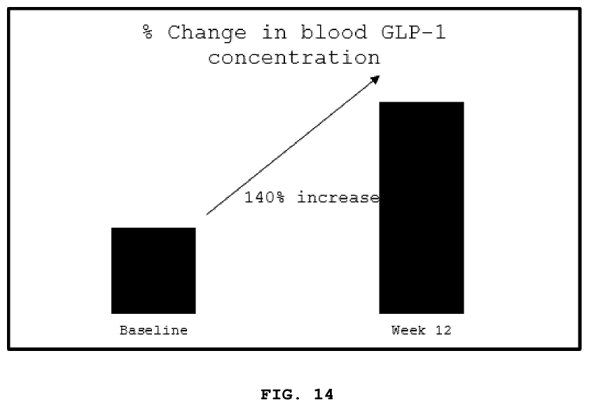

With respect to glucose levels, fasting GLP-1 levels increased on average in both the CG and TG group by 205% and 77% respectively, with an average increase in the blood of 140% over both groups at the end of the 12-week study as shown in FIG. 14. The fasting blood glucose levels showed no significant change throughout the 12-week study period.

The conclusion of this in vitro study is that the compositions described herein influence the genes in the pathway that ultimately lead to an increase in GLP-1 production. The MindBody GLP-1 System™ composition was given to human participants in a clinical study and was shown to increase GLP-1 concentrations in blood by an average of 140%. This composition activates the L-cells responsible for producing GLP-1, thereby producing more GLP-1 in the blood. As well, the participants' food and sugar cravings, as well as the urge to snack, decreased, leading to the weight loss seen. Few, if any, gastrointestinal side effects common with prescription medications were seen in the participants during the 12 weeks. And these compositions are able to obtain these results without binding directly to the GLP-1 receptors, like semaglutide and tirzepatide, which are GLP-1 receptor agonists.

The administration of the compositions described herein produced several desirable results. First, the MB Core™ composition and the MB Enhance™ composition naturally activate production of the GLP-1 protein and part of the GLP-1 production pathway. Second, there is a dual amplification since production of the DPP4 gene decreases, allowing for more GLP-1 to circulate and increases activation of GLP-1 receptors for more GLP-1 to bind to. Third, neuropeptides (including PYY and PPY) are activated, showing that there is an improved connection between the gut-brain axis. Fourth, consumption of the compositions naturally activated GLP-1 concentrations in the blood. Fifth, consumption of the compositions led to significant weight loss. Sixth, consumption of the compositions led to weight loss without muscle loss. Seventh, consumption of the compositions led to reduction in body fat percentage. Eighth, consumption of the compositions led to reduction in visceral fat percentage. Nineth, consumption of the compositions led to reduction in subcutaneous fat percentage. Tenth, consumption of the compositions led to subjective improvements in food and sugar cravings, meal and portion size, snacking, satisfaction between meals, and relationship with food.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A nutritional supplement composition, comprising:
about 8.14 to about 78.01 wt % hydrolyzed acacia gum;
about 3.54 to about 26.83 wt % lemon bioflavonoids;
about 0.007 to about 0.171 wt % chromium;
about 3.41 to about 26.09 wt % Berberis aristate; and
about 3.69 to about 43.35 wt % hesperidin.

2. The composition of claim 1 containing about 64 wt % hydrolyzed acacia gum.

3. The composition of claim 1 containing about 12.8 wt % lemon bioflavonoids.

4. The composition of claim 1 containing about 0.14 wt % chromium.

5. The composition of claim 1 containing about 6.6 wt % Berberis aristate

6. The composition of claim 1 containing about 7.1 wt % hesperidin.

7. A nutritional supplement composition, comprising:
about 2.497 to about 17.00 wt % flax seed oil;
about 6.573 to about 51.35 wt % resistant potato starch;
about 6.573 to about 51.35 wt % resistant tapioca fiber;
about 0.023 to about 2.253 wt % kombucha;
about 0.013 to about 0.253 wt % Bacillus coagulans;
about 0.013 to about 0.253 wt % Bacillus clausii; and
about 0.939 to about 4.523 wt % allulose.

8. The composition of claim 1 containing about 10.1 wt % flax seed oil.

9. The composition of claim 1 containing about 34.6 wt % resistant potato starch.

10. The composition of claim 1 containing about 34.6 wt % resistant tapioca fiber.

11. The composition of claim 1 containing about 0.2 wt % kombucha.

12. The composition of claim 1 containing about 0.025 wt % Bacillus coagulans.

13. The composition of claim 1 containing about 0.025 wt % Bacillus clausii.

14. The composition of claim 1 containing about 2.8 wt % allulose.

15. A nutritional supplement, comprising:
about 1 to about 2 grams of a first composition comprising:
about 8.14 to about 78.01 wt % hydrolyzed acacia gum;
about 3.54 to about 26.83 wt % lemon bioflavonoids;
about 0.007 to about 0.171 wt % chromium;
about 3.41 to about 26.09 wt % Berberis aristate; and
about 3.69 to about 43.35 wt % hesperidin;
and about 5 to about 6 grams of a second composition comprising:
about 2.497 to about 17.00 wt % flax seed oil;
about 6.573 to about 51.35 wt % resistant potato starch;
about 6.573 to about 51.35 wt % resistant tapioca fiber;
about 0.23 to about 2.253 wt % kombucha;
about 0.013 to about 0.253 wt % Bacillus coagulans;
about 0.013 to about 0.253 wt % Bacillus clausii; and
about 0.939 to about 4.523 wt % allulose.

16. A nutritional supplement, comprising:
about 5.2 wt % hydrolyzed acacia gum;
about 1.04 wt % lemon bioflavonoids;
about 0.001 wt % chromium;
about 0.52 wt % Berberis aristate;
about 0.52 wt % hesperidin;
about 11.4 wt % flax seed oil;
about 39 wt % resistant potato starch;
about 39 wt % resistant tapioca fiber;
about 0.1 wt % kombucha;
about 0.026 wt % Bacillus coagulans;
about 0.026 wt % Bacillus clausii; and
about 3.14 wt % allulose.

17. A method of activating GLP-1 and other hormones by administering a nutritional supplement composition to an individual, comprising:
about 5.2 wt % hydrolyzed acacia gum;
about 1.04 wt % lemon bioflavonoids;
about 0.001 wt % chromium;
about 0.52 wt % Berberis aristate;
about 0.52 wt % hesperidin;
about 11.4 wt % flax seed oil;
about 39 wt % resistant potato starch;
about 39 wt % resistant tapioca fiber;
about 0.1 wt % kombucha;
about 0.026 wt % Bacillus coagulans;
about 0.026 wt % Bacillus clausii; and
about 3.14 wt % allulose.

18. The method of claim 17, wherein the composition does not bind directly to the GLP-1 receptors.

19. The method of claim 17, wherein the GLP-1 concentration in the blood is increased by up to about 140%.

20. The method of claim 17, wherein administering the nutritional supplement composition to an individual resulted in a loss of body weight while maintaining or increasing the skeletal muscle.
